(19) United States
(12) Patent Application Publication
(10) Pub. No.: US 2008/0193907 A1
(43) Pub. Date: Aug. 14, 2008

(54) Method to analyze and improve creativity generated by a creative process

(75) Inventor: Steven PAUWELS, Viersel (BE)

Correspondence Address: AKERMAN SENTERFITT, P.O. BOX 3188, WEST PALM BEACH, FL, 33402-3188, US

(73) Assignee: CHOCO, Lier (BE)

(21) Appl. No.: 11/674,327

(22) Filed: Feb. 13, 2007

(51) Int. Cl. G09B 7/00

(52) U.S. Cl. 434/322

(57) ABSTRACT

Method to analyze and improve creativity generated by a creative process in which said creative process is audited to map out participants, goals and organizational structures of said creative process and parameters influencing said creative process, wherein the method comprises the following steps:
a) identifying among said parameters multiple pairs of contrasting parameters governing said creative process,
b) charting said multiple pairs of contrasting parameters as opposite poles in a matrix,
c) using said matrix to optimize creativity by balancing out said contrasting parameters towards a core of said matrix.

### FIELD OF THE INVENTION

The present invention relates to a method to analyze and improve creativity generated by a creative process in which said creative process is audited to map out participants, goals and organizational structures of said creative process and parameters influencing said creative process, as described in the preamble of the first claim.

### BACKGROUND

It is known to the person skilled in the art that a creative process can be analyzed and that the creativity generated by the creative process can be increased by auditing the creative process to map out participants, goals and organization structures after which the parameters influencing the creation of creativity of the creative process are mapped out and adapted to attempt an improvement in the generated creativity. For example, after mapping out the participants of the creative process, an attempt for increasing the creativity is made by challenging the participants of the creative process as a single group, different smaller groups or different individuals with creative tasks such as improvisation challenges, survival challenges, etc. In another example, by changing the organizational structure by for example tuning and/or changing the hierarchy in the organizational process an attempt is made to increase the generated creativity.

These methods however have the disadvantage that they do not efficiently increase the generated creativity by the creative process.

### SUMMARY OF THE INVENTION

Accordingly, it is the aim of the present invention to provide a method which more efficiently increases the generated creativity of the creative process.

This is achieved according to the present invention with a method showing all the features of the first claim.

Thereto, the method comprises the following steps:
a) identifying among said parameters multiple pairs of contrasting parameters governing said creative process,
b) charting said multiple pairs of contrasting parameters as opposite poles in a matrix,
c) using said matrix to optimize creativity by balancing out said contrasting parameters towards a core of said matrix.

The inventor has surprisingly found that when the contrasting parameters are balanced towards a core of the matrix, the creativity is optimized and the creation of creativity is increased. When the matrix has made clear which specific parameters have to be balanced with respect to the core, a specific strategy can be developed for each parameter or, when applicable, for a specific group of parameters therefore allowing a more purposive approach to increasing the generated creativity. The more purposive approach in increasing the generated creativity of the creative process renders the method far more efficient than any method known in the state of the art.

Since the inventor has found that the creativity is optimized when a pair of contrasting parameters is balanced towards the core of the matrix and since the increase of creativity is approached more systematically, the rate of success of the increase in generated creativity is greatly improved.

The more purposive approach for increasing the generated creativity allows more precisely planning allocation of resources, such as time, money, people, etc., depending on the desired increase in creativity, budget, envisioned time span, etc. The more purposive approach also allows more efficiently using the allocated resources allocated to increase the generated creativity of the creative process.

Since several parameters influencing the creative process are charted into the matrix, the inventor has found that a broad view on the creative process allows the purposive approach to cover several parameters possibly influencing several aspects of the creative process and is no longer directed to improving just one pair of specific parameters. The broad view on the several parameters influencing the creative process offers the possibility of a broad approach improving several pairs of contrasting parameters at once, therefore further improving the efficiency of the method.

By identifying among the parameters multiple pairs of contrasting parameters governing the creative process, the inventor has further found that reflection about the creative process is stimulated. This helps to analyze the creative process in an unprejudiced way. The unprejudiced attitude towards the creative process allows discovering and appointing all the parameters governing the creative process which allows balancing previously unknown contrasting parameters, further increasing the generated creativity.

By identifying among the parameters multiple pairs of contrasting parameters governing the creative process and by charting the multiple pairs of contrasting parameters as opposite poles in the matrix, the inventor has further found that a survey of the different parameters influencing the creative process is created. The matrix therefore offers a complete, reliable and easy to interpret visualization of the different parameters governing the creative process allowing an easy and fast interpretation and analysis of the creative process leading to the purposive approach to increasing the generated creativity.

The inventor has additionally found that the method according to the invention can be easily explained and taught. This allows the participants of the creative process to easily understand the method and to participate and cooperate in its implementation offering a more effective increase in the generated creativity.

In a preferred embodiment of the method according to the invention, following cycle for organizing generation of creativity is repeated:
i) generating creativity,
ii) giving shape to said generated creativity, resulting in a concrete realization of said generated creativity,
iii) communication of said concrete realization to said participants of said creative process,
iv) comprehension of said communication by said participants of said creative process,
v) education of said participants of said creative process, resulting in improved creative possibilities of said organizational structures and/or said participants,
vi) play of said participants with said education and said concrete realization, resulting in the generation of new creativity.

Different external parameters such as time, space, economical situation, etc. may influence at least some of the different parameters and may distort the balance of the pairs of different parameters. The inventor has found that by repeating the cycle, the increased creation of creativity by the creative process can be sustained. The inventor has even found that by following the cycle an additional increase in generated creativity can be accomplished. The effectiveness of the creation of creativity and the effectiveness of the increase in creation of creativity are therefore effectively and considerably increased.

In another preferred embodiment of the invention, the communication of said creative process towards society is audited and stimulated resulting in an improved image of said creative process. The improved image provides the creative process with a feel-good atmosphere which increases the generated creativity therefore further improving the effectiveness of the method according to the invention. Without wanting to be bound by any theory, the inventor believes that the feel-good atmosphere, for example, amongst other things increases motivation of the participants of the creative process.

In a further preferred embodiment, said pairs of contrasting parameters are respectively represented by lines, each of opposing end parts of each said line representing a contrasting parameters of said pair of contrasting parameters. More preferably, the lines intersect in said core of said matrix. Even more preferably said lines representing said pairs of contrasting parameters intersect each other in a central point. The inventor has found that when the different pairs of contrasting parameters are represented as such, the interpretation of the matrix becomes even easier rendering the desired increase in creation of creativity easier to accomplish.

In a further preferred embodiment of the method according to the invention said pairs of contrasting parameters comprise: giving and receiving commitment, giving and receiving responsibility and giving and receiving confidence between said participants and/or between said participants and said creative process and form a matrix of creation. The inventor has found that these pairs of contrasting parameters at least to great extent determine the goals, participants and organizational structure of the creative process. These parameters can be balanced by influencing the goals, the participants and the organization structure of the creative process. The inventor has found that by balancing these particular parameters a substantial increase in generated creativity by the creative process can be accomplished.

In a further preferred embodiment of the method according to the invention each step of said cycle is represented by a regular pentagon. More preferably, each of said regular pentagons representing step ii to vi comprises a different side of said regular pentagon representing said step i. Even more preferably, said pentagons representing steps i to vi are incorporated into a new regular pentagon which represents said step i of a new cycle. The pentagons offer a complete, reliable and easy to interpret visualization of the sustaining process allowing an easy and fast interpretation and analysis of the sustainment of the increase in creativity generated by the creative process.

### BRIEF DESCRIPTION OF THE DRAWINGS

The invention will be further elucidated by means of the following description and the appended figures.

FIG. 1 shows a matrix according to the invention, having three pairs of opposing poles representing contrasting parameters.

FIG. 2 shows another embodiment of the matrix according to the invention having eight pairs of opposing poles representing contrasting parameters.

FIG. 3a shows a representation of the cycle for organizing generation of creativity according to the invention.

FIG. 3b further clarifies the cycle of FIG. 3a.

FIG. 4 shows a representation of an improvement in communication of the creative process towards society.

### DETAILED DESCRIPTION OF THE PREFERRED EMBODIMENTS

In the method according to the invention the creative process is audited to map out participants, goals and organizational structures of the creative process and parameters influencing the creative process. The participants, goals, organization structures and parameters preferably are interpreted in the most broad sense known to the person skilled in the art.

The creative process can be for example a company, a music band, an orchestra or any other group of people working together such as a tribe, a city, a country, a region, etc. or even a single person such as an artist, a musician, a writer, an employee, an employer, an entrepreneur or any other single person thinking creatively.

The participants can be stakeholders, executive staff, employees, inhabitants of the tribe, city, country or region, artists involved in the making of music or any other members of the group possibly participating at the creative process.

The creative process can have any possible goal such as making profit, making music, writing a novel, attracting customers, providing a certain service, etc. In the context of a business the goals may be found in for example a mission statement or financial planning. The goal of a business however does not have to be explicitly stated in, for example, the mission statement or the financial planning.

The organizational structures can be any structure known to the person skilled in the art governing a group of participants involved in the creative process but can also be a single person. In the latter case the organizational structure can be for example the personal planning of the single person. In case the creative process is a business the organizational structure may be determined by the corporate structure of the business, other additional organization structures of the business are however possible.

The parameters influencing the process can be any known parameters influencing the creative process. The parameters influencing the creative process depend on the creative process. Several general examples will be given but these examples by no means limit the possible parameters possibly influencing the creative process.

The creative process can be superficially audited and mapped out but preferably is thoroughly audited and mapped out finding as much parameters as possible. A more thorough audit provides the method according to the invention with more data and information and allows a far more efficient increase in creativity and is therefore preferred. However, when only a limited increase in the creativity generated is desired, for example due to financial considerations, the method according to the invention can already generate a substantial increase in generated creativity based on a superficial audit of the creative process. As will be discussed later.

When the organizational structure is audited and the goals, participants, organizational structures and the parameters are mapped out, the method comprises a first step in which among the parameters influencing the creative process multiple pairs of contrasting parameters are identified. The inventor has found that creativity is generated by a plurality of polarities represented by the pairs of contrasting parameters. In a second step the pairs of contrasting parameters are charted as opposing poles in a matrix 1, 2.

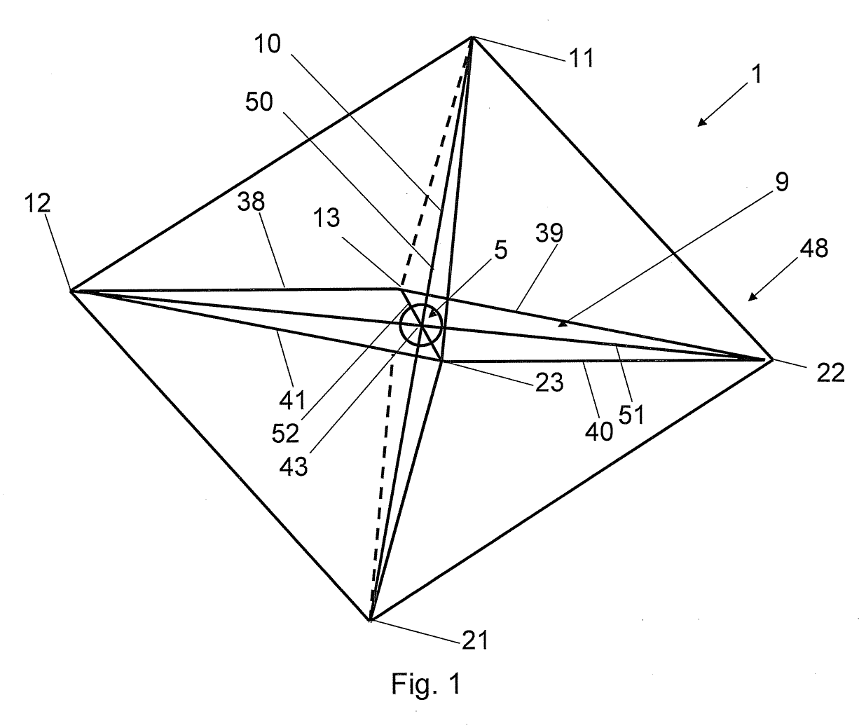

FIG. 1 shows a first embodiment of the matrix 1 according to the invention. The parameters of the pairs of contrasting parameters are respectively interconnected by lines 50, 51, 52, each of opposing end parts 11, 21, 12, 22, 13, 23 of each line 50, 51, 52 representing a contrasting parameter of the pair of contrasting parameters. The lines 50, 51, 52 intersect a core 5 of the matrix 1, in particular in a central point 43. It is preferred that the lines 50, 51, 52 intersect each other in the central point 43 since this increases the clarity of the matrix 1. This is however not critical to the invention and different embodiments of the core 5 of the matrix 1 are possible such as a rectangular or square region, a circular or elliptical region, etc. The core 5 where the different lines 50, 51, 52 intersect preferably represents the generation of creativity.

It is not critical to the invention that every parameter belongs to only one pair of contrasting parameter. A parameter can be part of different pairs of contrasting parameters. It is however preferred that every parameter belongs to just one pair of contrasting parameter to increase the clarity of the matrix 1.

The lines 50, 51, 52 interconnecting the different parameters can have any form known to the person skilled in the art such as straight, curved, angled, etc. but preferably are straight so that the interpretation of the matrix becomes even easier, rendering the desired increase in creation of creativity easier to accomplish. The lines 50, 51, 52 can be full or can be dashed and can have any color known to the person skilled in the art. This, however, can be determined by the person skilled in the art according to the position, function, representation, etc. of the lines and/or in function of the meaning of the lines. For example one line can be more important, for example when the pair of contrasting parameters represented by that line have an exceptional large influence on the generated creativity of the creative process, than another line and can thereto have different color and/or can be dashed, bold, etc.

The contrasting parameters preferably are positioned around the core 5 of the matrix 1 as shown in FIG. 1. The contrasting parameters more preferably are positioned on opposing sides of the core 5 of the matrix 1. This is however not critical for the invention and different locations for the parameters of a pair of contrasting parameters are possible such as positioning first elements of the pairs of contrasting parameters on a first side of the core 5 and second parameters of the pairs of contrasting parameters on a second opposing side of the core 5 of the matrix 1. In another example the contrasting parameters of a pair of contrasting parameters are positioned next to each other with the line interconnecting them running through the centre 5 of the matrix 1. The embodiment in which the parameters of the pairs of contrasting parameters are located around and on opposing sides of the core 5 is however preferred since the interpretation of the matrix 1 becomes easier.

The end parts of the lines 50, 51, 52 are point-shaped. The end parts of lines 50, 51, 52 interconnecting the parameters of the pairs of parameters can however have any form and/or shape deemed appropriate by the person skilled in the art such as square, a circular, an arrow, etc.

The matrix 1 comprises three pairs of contrasting parameters: a first pair 11, 21 interconnected by a first line 50, a second pair 12, 22 interconnected by a second line 51 and a third pair 13, 23 of contrasting parameters interconnected by a third line 52. The matrix 1 can however comprise more or less pairs of contrasting parameters as exemplified further on.

In the embodiment shown in FIG. 1 the three lines 50, 51, 52 are three-dimensionally arranged around the centre 5 forming a three-dimensionally cross. This is however not critical to the invention and the lines 50, 51, 52 can be arranged in a two-dimensional plane as will be discussed further on.

In the embodiment shown in FIG. 1, the end parts 11, 21, 12, 22, 13, 23 of the different lines 50, 51, 52 are interconnected forming an octahedron 48 to symbolize the interconnectivity and interdependence of the three pairs of contrasting parameters.

In a specific embodiment of the invention the end parts 11, 21 of the first line 50 respectively represent giving and receiving confidence, the end parts 12, 22 of the second line 51 respectively represent giving and receiving commitment and the end parts 13, 23 of the third line 52 respectively represent giving and receiving responsibility and the matrix 1 is called, in this specific embodiment, a matrix of creation. The contrasting parameters giving and receiving confidence, commitment and responsibility are present in almost all creative processes and are almost always necessary to attain the goals of the creative structure. The end parts 11, 21, 12, 22, 13, 23 of the three pairs of contrasting parameters may however represent other parameters in stead.

In a preferred embodiment of the invention the first line 50 represents transparency of the creative process for the participants, the second line 51 represents the drive created by the creative process for the participants of the creative process and the third line 52 represents the decisiveness of the participants created by the creative process. The interpretation of the first 50, second 51 and third 52 lines helps to analyze, understand and interpret the matrix 1 but is not critical for the invention. The interpretation of the first 50, second 51 and third 52 lines can be adapted according to the specific situation or according to the parameters located at the end part 11, 12, 13, 21, 22, 23 of the first 50, second 51 and third 52 lines. The interpretation of the meaning of the first 50, second 51 and third 52 lines can be determined by the person skilled in the art.

The lines 38, 39, 40 and 41 interconnecting the end parts 12, 22, 13, 23 of the second 12, 22 and the third 13, 23 pair delimit a plane 9 which, in a preferred embodiment of the invention, represents a field of activity in which the creative process can realize the goals of the creative process. The lines 38, 39, 40 and 41 also delimit the lines 50, 51 and 52 which represent the pairs of contrasting parameters. The lines 38, 39, 40 and 41 are related to different aspects of the creative process and their meaning depends from the parameters which they interconnect. Line 38 represents craftsmanship and interconnects the end parts 12 and 13, line 39 relates to the organizational structure and represents the responsibility given by the participants to the creative process by interconnecting end parts 13 and 22, line 40 also relates to the organizational structure and represents the responsibility given by the creative process to the participants by interconnecting end parts 22 and 23 and line 41 relates to the cooperation between the participants and the creative process and represents the amount of initiative taken by the participants with respect to the creative process by interconnecting end parts 12 and 23.

The interpretation of the lines 38, 39, 40 and 41 helps to analyze, understand and interpret the matrix 1 but is not critical for the invention. The interpretation of the lines 38, 39, 40 and 41 can be adapted according to the specific situation or according to the parameters located at the end parts 11, 12, 13, 21, 22, 23 of the first 50, second 51 and third 52 lines. The interpretation of the meaning of the lines 38, 39, 40 and 41 can be determined by the person skilled in the art.

In a further preferred embodiment of the method according to the invention the end part 11 of the first line 50 representing giving confidence represents publicly known goals of the creative process. The publicly known goals, which are also called the implicit missions, are the goals which have their origin in the conceptual phase of the creative process and are the sum of all the intentions of the initiators of the creative process. When the initiators of the creative process decide to start the creative process, the implicit missions are subject to time, space and other parameters influencing the creative process. Space relates to the field of activity which is represented by the plane 9. Time can be represented as a dimension which is perpendicular to space, therefore time can be represented by the first line 50 interconnecting the end parts 11, 12 of the first pair of contrasting parameters. In this representation the publicly known goals or implicit missions expands from a single point of the end part 11 representing giving trust to a plane 9 representing the field of activity in which the implicit mission are realized between the boundaries set by the lines 38, 39, 40 and 41 each with its representation depending from the contrasting parameters which they interconnect.

The end part 21 of the first line 50 representing receiving confidence represents, in a further preferred embodiment, publicly unknown goals or the secret missions of the creative process. The secret missions also determine the plane 9 but from a side opposing the implicit missions symbolizing the secret character of the secret mission.

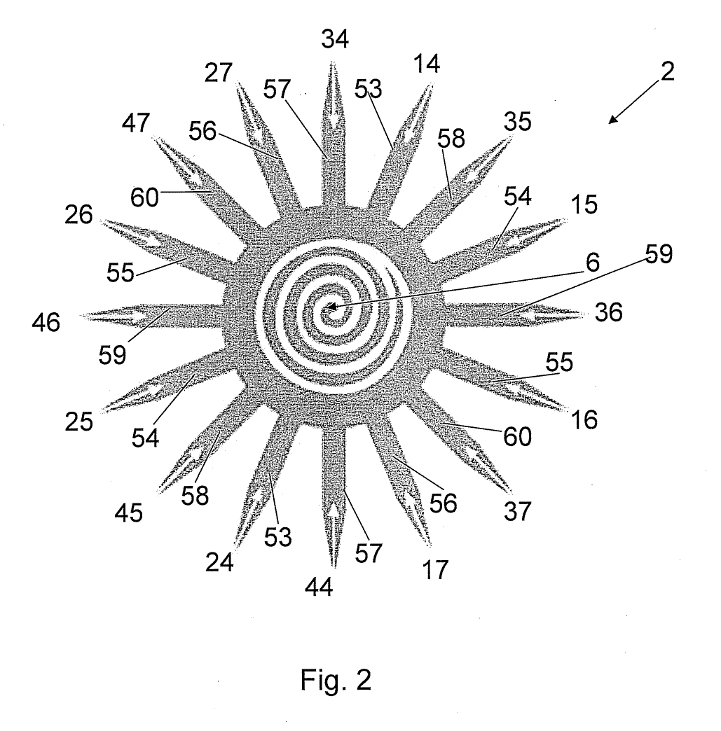

The matrix 2 shown in FIG. 2 differs from the matrix 1 of FIG. 1 in that the matrix 2 comprises a different number of pairs of contrasting parameters. The number of pairs of contrasting parameters is, as discussed earlier on, not critical for the invention and can be adapted to the creative process, goals of the creative process, participants, etc. The respective end parts 14-17, 24-27, 34-37 and 44-47 of the lines 53-60 represent different parameters than the preferred parameters of FIG. 1 which are giving and receiving commitment, responsibility and confidence. A further difference is that the lines 53-60 interconnecting the different pairs of contrasting parameters are positioned in a plane.

In this embodiment, the matrix 2 relates to what is called creative energy which is a way of denoting the ability to generate creativity. The matrix 2 preferably represents different parameters influencing the creative energy. The matrix 2 therefore offers a way to clearly represent the different parameters influencing the creative energy of a creative process.

In a preferred embodiment of the matrix 2, the pairs of contrasting parameters preferably comprise two groups: a first group representing specific parameters with respect to the creative process represented by the end parts 14-17 with the corresponding end parts 24-27 respectively representing the contrasting parameters represented by the end parts 14-17 interconnected by respective lines 53-56 and a second group representing generic parameters of the creative process represented by the end parts 34-37 with the corresponding end parts 44-47 respectively representing the contrasting parameters represented by the end parts 34-37 interconnected by respective lines 57-60. Dividing the pairs of contrasting parameters into these two groups is not critical for the invention but further clarifies the matrix 2. The pairs of contrasting parameters can also be divided in more than two groups further clarifying the matrix 2 of contrasting parameters sharing other mutual or resembling parameters. This however depends on the creative process, the participants of the creative process and the parameters, the organizational structure and the goals of the creative process and is not critical for the invention.

In a more preferred embodiment according to the invention the pairs of the first group of contrasting parameters alternate with the second group of contrasting parameters. This is however not critical for the invention and the pairs of contrasting parameters of the respective groups may for example be grouped together as a whole or in pairs of two, three or more. The number of pairs of contrasting parameters does not need to be the same in all of the groups.

In a first example, the matrix 2 represents the creative energy of a human being. In this case, the following pairs of contrasting parameters from the group of generic parameters could surround the centre of the matrix 2: me, end part 34—the world, end part 44, culture, end part 35—experiences, end part 45, possibilities, end part 36—personality, end part 46 and meetings, end part 37—fellows, end part 47. The specific parameters are parameters which are specific for the human being such as for example: extrovert, end part 14—introvert, end part 24, brave, end part 15—rational, end part 25, humoristic, end part 16—serious, end part 26 and thinker, end part 17—doer, end part 27.

In a second example, the matrix 2 represents the creative energy for economical or commercial development. In this case, the following pairs of contrasting parameters from the group of generic parameters could surround the centre of the matrix 2: market, end part 34—society, end part 44, marketing, end part 35—values, end part 45, consumer, end part 36—company, end part 46 and mark, end part 37—product, end part 47. The specific parameters are parameters which are specific for the economical or commercial development.

In a third example, the matrix represents the creative energy of a company. The pairs of contrasting parameters in this case are not divided into two groups. In this case the following pairs of contrasting parameters can be positioned around the centre 6 of the matrix 2: aura, end part 14—dynamics, end part 24, personality, end part 15—image, end part 25, anchoring, end part 16—dialogue, end part 26, imaging, end part 17—harmony, end part 27, corporate identity, end part 34—signals, end part 44, culture, end part 35—identity, end part 45, perception, end part 36—roots, end part 46 and associations, end part 37—values, end part 47. In this case additional end parts representing radius—vision and tone—opinion can be added to the matrix 2.

The parameters listed in the three examples of the matrix 2 representing the creative energy of the different creative processes is not limited and additional or less parameters can be included in the matrix 2.

A second step of the method according to the invention comprises balancing out the contrasting parameters towards the core 5, 6 of the matrix 1, 2. The inventor has found that when the contrasting parameters are balanced towards the core 5, 6 of the matrix 1, 2, the generated creativity is increased. Balancing the pairs of contrasting parameters towards the core 5, 6 of the matrix 1, 2 can be done according to any known method according to the person skilled in the art and depends from the nature of the pairs of contrasting parameters.

The more pairs of contrasting parameters are represented in the matrix 1, 2, the more pairs of parameters can be balanced towards the core 5, 6 of the matrix 1, 2 and the more the generation of creativity can be increased. In a preferred embodiment of the invention, as much parameters as possible are incorporated into the matrix 1, 2.

The different pairs of contrasting parameters can also be balanced with respect to each other, tuning the different pairs of contrasting parameters with respect to each other. The pairs of contrasting parameters can also be grouped together so that different groups of pairs of contrasting parameters can be balanced with respect to each other. The parameters which have to be balanced with respect to each other can be determined by the person skilled in the art.

In a preferred embodiment of the lines 53-60 of the matrix 2 interconnecting the parameters of the pairs of contrasting parameters differ from the lines 50, 51, 52 of the matrix 1 in that the different lines 53-60 have a shape which indicates the possibility of an inward movement of the end parts 14-17, 24-27, 34-37 and 44-47 towards the core 6 of the matrix 2, indicated with the white arrows, and the possibility of an outward movement of the end parts 14-17, 24-27, 34-37 and 44-47, indicated with the grey arrow-shaped region surrounding the with arrows. The shape and/or form of the arrows indicating the inward and outward movement of the end parts 14-17, 24-27, 34-37 and 44-47 is however not critical for the invention and can be determined by the person skilled in the art and can for example be a double-headed arrow at the end parts 14-17, 24-27, 34-37 and 44-47 of the lines 53-60 interconnecting the contrasting parameters. Suggesting the possibility of an inward or outward movement of the end parts 14-17, 24-27, 34-37 and 44-47 has the advantage that the matrix 2 is more easily understood since the increase in generated creativity by balancing the pair of contrasting parameters to the core 6 of the matrix 2 is already suggested in the form and shape of the matrix 2 and helps to understand and employ the method according to the invention.

The increase in creativity accomplished with the method according to the invention is however subject to different external parameters such as time, space, economical situation, etc. influencing, at least some of the different parameters and distorting the balance of the pairs of different parameters therefore distorting the creation of creativity in the creative process. The inventor has found that when following cycle is repeated the generation of creativity is organized and sustained:
i) generating creativity,
ii) giving shape to said generated creativity, resulting in a concrete realization of said generated creativity,
iii) communication of said concrete realization to said participants of said creative process,
iv) comprehension of said communication by said participants of said creative process,
v) education of said participants of said creative process, resulting in improved creative possibilities of said organizational structures and/or said participants,
vi) play of said participants with said education and said concrete realization, resulting in the generation of new creativity.

The first step of the cycle is governed by charting the contrasting parameters as opposite poles in the matrix 1, 2 and balancing them out towards the core 5, 6 of the matrix 1, 2 as discussed earlier on. Different parameters influencing the creation of creativity are for example: to be, to choose, to believe, to realize, to dare, etc.

The second step in fact gives perception to the creativity generated in the first step. Hereto, the creative process needs the organizational structure of the creative process. The organizational structure of the creative process can in its turn depend on other parameters. In case the creative process is a commercial organization for example: logistics, product, marketing, sales, distribution, etc. Since a concrete realization is made in this step, the step can also be denoted with the words “to make”.

The third step sets the concrete realization of the generated creativity in motion by communicating it to the different participants of the creative process. More preferably, the participants are informed, stimulated and/or motivated. Communication in this step can also be denoted with “to radiate”.

To assure that the generated creativity keeps circulating through the creative process, the fourth step provides the participants with insight and comprehension into the generated creativity for example provided by ambitions, visions, concepts, techniques, try-outs, etc. or by for example confronting the generated creativity with non-participants. Comprehension in this step can also be denoted with “to care about”.

The fifth step develops the creative possibilities of the organizational structures and/or said participants. The organizational structure can for example be audited or the participants can for example be coached or trained in specific skills. The development in this step can also be denoted with “to grow”.

By allowing the participants to play, the sixth step ensures that the participants of the creative process have the possibility to develop new creativity, for example by brainstorming, fieldtrips, etc. In a preferred embodiment of the sixth step, the participants are not forced to develop creativity but are encouraged to use their skills to inpurposively find new creativity. The play in this step can also be denoted with “to enjoy”.

The inventor has found that by employing these steps in a creative process, the different pairs of contrasting parameters are balanced towards the core 5, 6 of the matrix 1, 2 and therefore that the generation of creativity can be sustained notwithstanding the influence of space, time, etc.

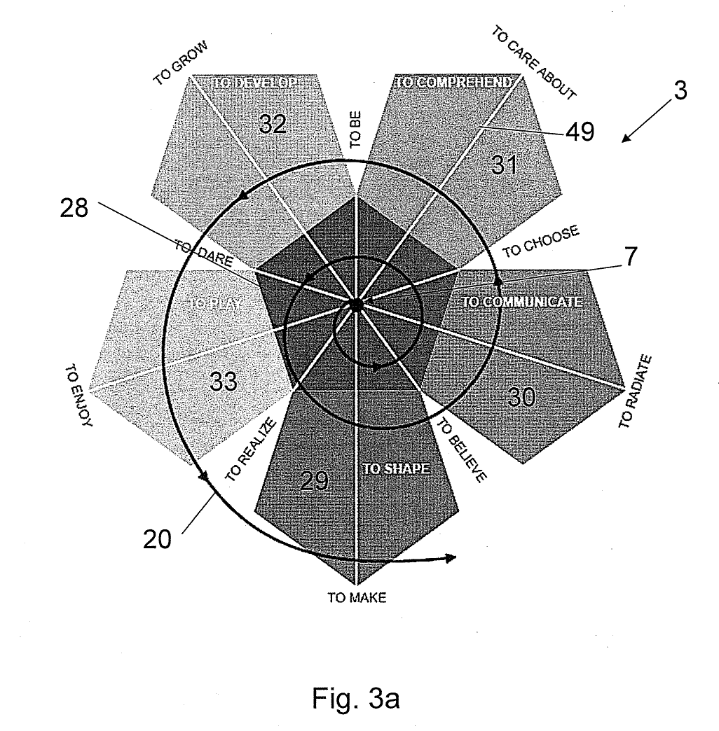

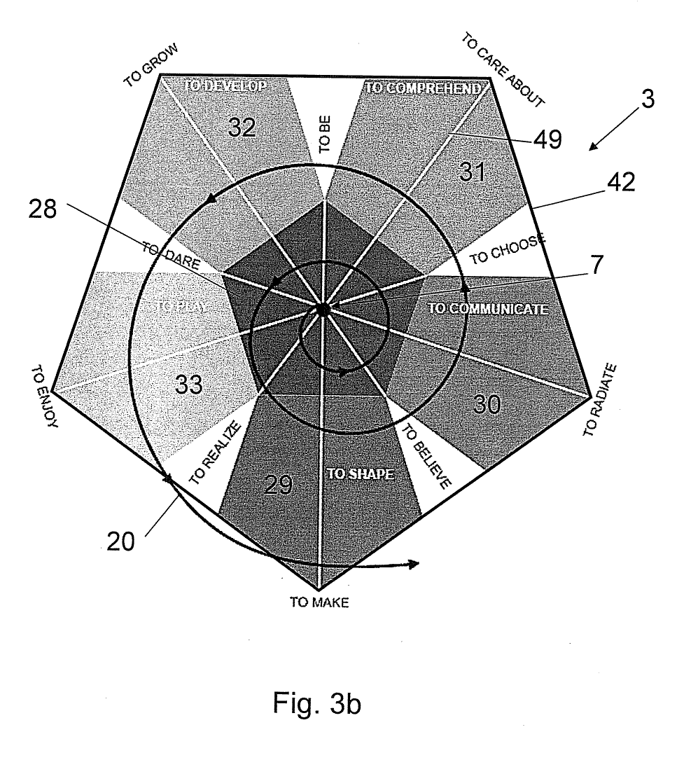

FIG. 3a shows a visualization 3 of the cycle so that the cycle can be better taught, understood, applied, etc. In FIG. 3a every step of the cycle is represented by a regular pentagon 28-33. The pentagon representing second 29 (to shape), third 30 (to communicate), fourth 31 (to comprehend), fifth 32 (to develop) and sixth step 33 (to play) surround the pentagon representing the first step 28. The pentagon representing the second 29, third 30, fourth 31, fifth 32 and sixth 33 step are equal and all comprise a different side of the pentagon representing the first step 28. To symbolize the cyclic movement through the different steps of the cycle, a spiral 20 with its origin in a core 7 of the first pentagon 28 representing the first step is drawn through the different pentagons 28-30 representing the steps of the cycle. The core 7 represents the origin of the generated creativity.

The parameters influencing the creation of creativity are arranged around the central first pentagon 28, since five parameters are given they can be arranged at the corners of the first pentagon 28. Other arrangements can be determined by the person skilled in the art such as a list or a composition of words written in the first pentagon 28 or the parameters can be omitted from the figure.

The alternative denotations for the different steps of the cycle are written at the outer top of the pentagons 29-33 surrounding the central pentagon 28. This is however not critical to the invention and the alternative denotations can be omitted from the figure or can be written in another configuration.

FIG. 3b is different from the pentagons of FIG. 3a since it comprises a seventh pentagon 42 drawn around the five pentagons 29-33 of FIG. 3a. The seventh pentagon 42 represents the new pentagon representing the new first step creating creativity. The steps succeeding the newly created first step can now be placed around the surrounding seventh pentagon 42. When the spiral 20 is followed an endless chain of pentagons can be drawn, representing the endless cycle sustaining the creation of creativity. The spiral 20 broadens when running through the pentagons and therefore symbolizes the increase in generated creativity.

By representing the different steps of the cycle by regular pentagons, the steps are symmetrically represented and an easier interpretation of the cycle is possible making it easier to teach, apply, understand, etc. the cycle.

The representation of the steps by regular pentagons is not critical for the invention. The steps can for example be represented by different polygons such as squares, triangles, spheres, circles, etc. The shapes representing the different steps of the cycle do not need to be plane but can also be three-dimensional.

The preferred form of the shapes representing the different steps for example depends from the number of steps of the cycle. When for example a cycle is used which only comprises five steps, the different steps can be represented by a square.

The arrangement of the pentagons 28-33 with respect to each other is not critical for the invention and can be determined by the person skilled in the art. The arrangement of the five pentagons 29-33 surrounding the pentagon 28 representing the first step is however preferred since in such an arrangement the cycle can be represented by drawing a new pentagon 42 around the five pentagons 29-33 surrounding the pentagon 28 representing the first step of the cycle.

The different steps however remain in contact with the core 7 of the cycle. This is represented in FIG. 3a with the lines 49 extending from the core 7 of the central pentagon 28 towards the outer corners of the surrounding pentagons 29-33. The lines 49 symbolize the increase in generated creativity achieved with each step.

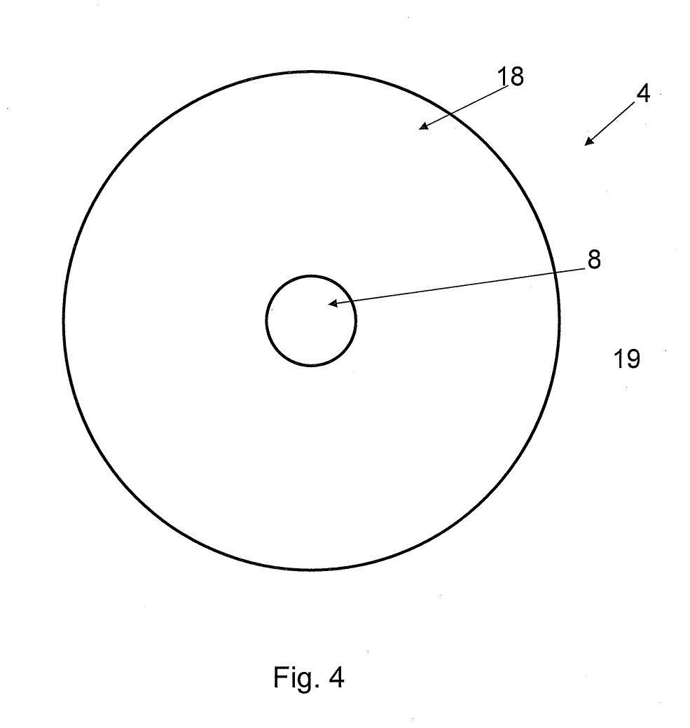

In recent times the image of a creative process to non-participants of the creative process has broadened and the creative process has far more contact with the non-participants. For example, the image of a company is no longer only determined by advertisement campaigns but is also determined by other factors such as personnel policy, etc. Communication towards society is no longer offered to society but society demands and partly determines the communication of the creative process. FIG. 4 shows a preferred embodiment of a visualization 4 called “timescape of creative energy” to cope with this new situation. The outer circle 18 delimits the creative process from society which is represented by the space 19 around it, symbolizing the larger amount of contact with society. The inner circle 8 represents the core of the creative process from which the creativity is generated. The creative process is surrounded with society and can offer information to it when it demands it. Society however surrounds the creative process and can communicate back to the creative process. The improved image provides the creative process with a feel-good atmosphere which increases the generated creativity therefore further improving the effectiveness of the method according to the invention. Without wanting to be bound by any theory, the inventor believes that the feel-good atmosphere, for example, amongst other things increases motivation of the participants of the creative process.

The representation of the new strategy for communication with society is not critical for the invention. The creative process can for example be only partly delimited from society or can be represented by a different shape such as a random polygon, a square, a triangle, etc. The circular shape is however preferred since the circle represents the equal distance of the surrounding society to the centre 8 creating creativity and therefore to the core of the creative process.

The core 8 of the creative process creating the creativity can have any shape and form deemed appropriate by the person skilled in the art. The core 8 preferably is located in the centre of the outer circle 18 symbolizing the shielded character of the core 8 while having an equal distance to the different member of society at the outer circle 18 symbolizing an equal treatment of every demand/offer of communication. The core 8 can also be completely omitted from the representation of the communication of the creative process with society.

When applying the matrix 1 of creation, the matrix 2 representing the creative energy by the different contrasting parameters, the cycle to sustain and increase the generated creativity and the timescape of creative energy a significant increase in creativity generated by the creative process with its particular goals, organizational structure and participants can be achieved and sustained while the parameters influencing the creative process change under the influence of parameters such as time, space, etc. The increase in generated creativity and the improved communication towards society allows the creative process to achieve its goals more efficiently, helping the creative process to be successful.

1. Method to analyze and improve creativity generated by a creative process in which said creative process is audited to map out participants, goals and organizational structures of said creative process and parameters influencing said creative process, wherein the method comprises the following steps:
a) identifying among said parameters multiple pairs of contrasting parameters governing said creative process,
b) charting said multiple pairs of contrasting parameters as opposite poles in a matrix,
c) using said matrix to optimize creativity by balancing out said contrasting parameters towards a core of said matrix.

2. Method according to claim 1, wherein following cycle for organizing generation of creativity is repeated:
i) generating creativity,
ii) giving shape to said generated creativity, resulting in a concrete realization of said generated creativity,
iii) communication of said concrete realization to said participants of said creative process,
iv) comprehension of said communication by said participants of said creative process,
v) education of said participants of said creative process, resulting in improved creative possibilities of said organizational structures and/or said participants,
vi) play of said participants with said education and said concrete realization, resulting in the generation of new creativity.

3. Method according to claim 1, wherein communication of said creative process towards society is audited and stimulated resulting in an improved image of said creative process.

4. Method according to claim 1, wherein said pairs of contrasting parameters are respectively represented by lines, each of opposing end parts of each said line representing one parameter of said pair of contrasting parameters.

5. Method according to claim 4, wherein said lines intersect in said core of said matrix.

6. Method according to claim 4, wherein said lines representing said pairs of contrasting parameters intersect each other in a central point.

7. Method according to claim 4, wherein said pairs of contrasting parameters comprise: giving and receiving commitment, giving and receiving responsibility and giving and receiving confidence between said participants and/or between said participants and said creative process and form a matrix of creation.

8. Method according to claim 7, wherein said lines representing said pairs of contrasting parameters form a three dimensional cross.

9. Method according to claim 8, wherein said end parts of said different lines are interconnected by lines forming an octahedron.

10. Method according to claim 9, wherein said matrix of creativity comprises a plane comprising said line representing receiving and giving commitment and said line receiving and giving responsibility, said plane being delimited by further lines interconnecting said end parts of said lines, wherein said plane represents a field of activity in which said creative process can realize said goals, wherein said line representing giving and receiving confidence, which extends perpendicular to said plane, has a first end part representing publicly known goals of said creative process and a second end part representing publicly unknown goals of said creative process.

11. Method according to claim 6, wherein said lines representing said pairs of contrasting parameters are positioned in a plane.

12. Method according to claim 2, wherein each step of said cycle is represented by a regular pentagon.

13. Method according to claim 12, wherein each of said regular pentagons representing step ii to vi comprises a different side of said regular pentagon representing said step i.

14. Method according to claim 13, wherein said pentagons representing steps i to vi are incorporated into a new regular pentagon which represents said step i of a new cycle.
